(19) United States
(12) Patent Application Publication
(10) Pub. No.: US 2026/0346552 A1
(43) Pub. Date: Nov. 5, 2026

(54) FILAMENT WINDING APPARATUS

(71) Applicant: Murata Machinery, Ltd., Kyoto-shi, Kyoto (JP)

(72) Inventors: Motohiro Tanigawa, Kyoto-shi, Kyoto (JP); Masatsugu Goyude, Kyoto-shi, Kyoto (JP); Toshihiro Matsui, Kyoto-shi, Kyoto (JP); Hirotaka Wada, Kyoto-shi, Kyoto (JP); Yoshihiro Kino, Kyoto-shi, Kyoto (JP); Hidehiro Takeoka, Kyoto-shi, Kyoto (JP); Yasuhiro Sakanashi, Kyoto-shi, Kyoto (JP); Dai Shimizube, Kyoto-shi, Kyoto (JP); Daigoro Nakamura, Kyoto-shi, Kyoto (JP)

(73) Assignee: Murata Machinery, Ltd., Kyoto-shi, Kyoto (JP)

(21) Appl. No.: 19/487,251

(22) PCT Filed: Feb. 29, 2024
(86) PCT No.: PCT/JP2024/007457

§ 371 Date: Nov. 24, 2025

(30) Foreign Application Priority Data
May 30, 2023 (JP) 2023-088495

(51) Int. Cl. B29C 70/32; B29C 70/54

(52) U.S. Cl. CPC B29C 70/32; B29C 70/54

(57) ABSTRACT

A filament winding apparatus includes a supporting unit which supports a liner, a helical winding unit configured to helical-wind fiber bundles onto the liner; and a yarn end processor. The yarn end processor includes a main body, gripping portions, cutting units, a movement drive unit, a rotational drive unit, and an extension/contraction drive unit. The movement drive unit includes a moving motor, and is able to move the main body in a liner axial direction. The rotational drive unit includes a rotating motor, and is able to rotationally drive the main body in a liner circumferential direction. The extension/contraction drive unit includes an extension/contraction motor, is able to open and close the gripping portions in the liner axial direction, and is able to move the cutting units toward the gripping portions in the liner axial direction while the gripping portions are closed.

### CROSS REFERENCE TO RELATED APPLICATIONS

This application is a US national stage filing under 35 U.S.C. § 371 of International Application No. PCT/JP2024/007457 filed Feb. 29, 2024, which claims priority to Japanese Patent Application No. 2023-088495 filed May 30, 2023, each of which is incorporated herein by reference in its entirety.

### TECHNICAL FIELD

This disclosure relates to a filament winding apparatus configured to wind a fiber bundle onto a liner.

### BACKGROUND

Japanese Laid-Open Patent Publication No. 2021-79548 discloses a filament winding apparatus configured to wind fiber bundles onto a liner. The filament winding apparatus includes: a supporting unit which supports the liner to be substantially horizontal; a helical winding unit configured to perform helical-winding onto the liner; and a fiber bundle retainer (hereinafter, this will be referred to as a yarn end processor). To be more specific, the helical winding unit is configured to guide the fiber bundles radially inward of the liner by using the respective nozzle units (hereinafter, those will be referred to as fiber bundle guides) arranged in a circumferential direction of the liner (hereinafter, this will be simply referred to as the circumferential direction). When the fiber bundles supplied from the helical winding unit are separated from the liner, the yarn end processor temporarily holds and cuts intermediate parts of the fiber bundles.

To be more specific, the yarn end processor includes a holding mechanism which is movable relative to the supporting unit in the axial direction. The holding mechanism includes: gate portions provided to correspond to the number of the fiber bundles; protruding portions provided similarly to the gate portions; and a cutter configured to cut the fiber bundles. The gate portions and the protruding portions are configured to grip the intermediate parts of the fiber bundles, which are guided to the liner, by moving in the circumferential direction. After that, as the cutter revolves in the circumferential direction, the fiber bundles are cut in order.

The above-described yarn end processor needs a lot of (specifically, four) driving sources. That is, the yarn end processor needs a motor configured to move the holding mechanism relative to the supporting unit in its axial direction, a motor configured to revolve the gate portions in the circumferential direction, a motor configured to revolve the protruding portions in the circumferential direction, and a motor configured to revolve the cutter in the circumferential direction.

It could therefore be helpful to provide a filament to reduce the number of driving sources necessary for a yarn end processor.

### SUMMARY

A filament winding apparatus is configured to wind fiber bundles onto an outer circumferential surface of a liner, including: a supporting unit which supports the liner;, a helical winding unit which includes fiber bundle guides and which is configured to helical-wind the fiber bundles onto the liner, the fiber bundle guides being aligned in a circumferential direction of the liner and configured to guide the respective fiber bundles to the liner, and a yarn end processor which is able to grip and cut the fiber bundles. The yarn end processor includes: a main body which is movable relative to the supporting unit in an axial direction of the liner, gripping portions which are provided at the main body, which are aligned in the circumferential direction, which are able to grip parts of the respective fiber bundles, and which are openable and closeable in the axial direction, the parts of the respective fiber bundles being positioned between the fiber bundle guides and the liner in a fiber bundle running direction, cutting units which are provided at the main body to correspond to the respective gripping portions, which are able to cut parts of the fiber bundles gripped by the gripping portions, and which are movable in the axial direction, the parts of the fiber bundles gripped by the gripping portions being positioned between the gripping portions and the liner in the fiber bundle running direction, a first drive unit which includes a first driving source and which is able to move the main body in the axial direction;, a second drive unit which includes a second driving source different from the first driving source and which is able to rotationally drive the main body in the circumferential direction, and a third drive unit which includes a third driving source different from both the first driving source and the second driving source, which is able to open and close the gripping portions in the axial direction, and which is able to move the cutting units relative to the gripping portions in the axial direction while the gripping portions are closed.

The yarn end processor is configured to grip the fiber bundles, which are supplied via the fiber bundle guides, by using the gripping portions and to cut and separate these fiber bundles from the liner. To be more specific, the fiber bundles are separated from the liner as described below. To begin with, the fiber bundles extend inward from the respective fiber bundle guides toward the liner in a radial direction of the liner. In this condition, the main body is moved toward the fiber bundles in the axial direction by the first drive unit. Subsequently, while (i) the main body is provided at a suitable position in the axial direction and (ii) the gripping portions are provided between the fiber bundles in the circumferential direction, the gripping portions are opened in the axial direction by the third drive unit. Because of this, one of each paired grip members is provided on one side of the fiber bundles in the axial direction, and the other of each paired grip members is provided on the other side of the fiber bundles in the axial direction. Subsequently, as the main body is rotated in the circumferential direction by the second drive unit, the open gripping portions move in the axial direction to sandwich the respective fiber bundles. After that, as the third drive unit closes the gripping portions in the axial direction, the gripping portions grip the respective fiber bundles. Furthermore, as the third drive unit moves the cutting units in the axial direction, the fiber bundles gripped by the gripping portions are cut by the respective cutting units. As described above, the yarn end processor is driven by the three drive units. With this arrangement, the number of driving sources is reduced to three. It is therefore possible to reduce the number of the driving sources necessary for the yarn end processor.

The filament winding apparatus of the first aspect is arranged such that each of the gripping portions includes: a first grip member; and a second grip member which is movable relative to the first grip member in the axial direction and which is able to grip corresponding one of the fiber bundles with the first grip member, the first grip member includes first comb teeth portions which are aligned in an orthogonal direction orthogonal to the circumferential direction when viewed in the axial direction, the second grip member includes second comb teeth portions which are aligned in the orthogonal direction, and the first comb teeth portions and the second comb teeth portions are alternated in the orthogonal direction.

Each of the gripping portions is structured so that the corresponding one of the fiber bundles is properly gripped by the teethed first grip member and the teethed second grip member.

The filament winding apparatus of the first or second aspect is arranged such that the yarn end processor includes receivers which are provided to correspond to the cutting units and which are configured to sandwich the respective fiber bundles with the cutting units, the third drive unit includes a moving member which is moved by the third driving source in the axial direction, each of the cutting units includes: a blade part which is aligned with corresponding one of the receivers in the axial direction, which is movable relative to the moving member in the axial direction, and which is able to sandwich one of the fiber bundles with the corresponding one of the receivers and to cut the one of the fiber bundles; and an elastic portion which is interposed between the moving member and the blade part and which is able to elastically deform in the axial direction, and when the blade part is provided at a position to sandwich the one of the fiber bundles with the corresponding one of the receivers, the elastic portion is able to elastically deform to bias the blade part toward the corresponding one of the receivers in the axial direction.

As the moving member is moved in the axial direction by the third driving source, the one of the fiber bundles is sandwiched between the blade part of the each of the cutting units and the corresponding one of the receivers. After that, even when the moving member is further moved in the axial direction, the elastic portion elastically deforms in the axial direction to easily change the relative positions of the moving member and the blade part in the axial direction. It is therefore possible to prevent the damage of the yarn end processor due to an excessive force applied to a position between the blade part and the corresponding one of the receivers. The blade part is biased toward the corresponding one of the receivers by an elastic restoring force generated when the elastic portion elastically deforms. Because of this, the one of the fiber bundles which is sandwiched between the blade part and the corresponding one of the receivers is reliably cut by the blade part.

### BRIEF DESCRIPTION OF THE DRAWINGS

FIG. 1 is a perspective view of a filament winding apparatus.

FIG. 2 is a block diagram of the electric configuration of the filament winding apparatus.

FIG. 3(a) and 3(b) are front views of a helical winding unit.

FIG. 4(a) and 4(b) are profiles of a yarn end processor and its surroundings.

FIG. 5 is a perspective view of a holding cutting mechanism.

FIG. 6 is a front view of the holding cutting mechanism and its surroundings.

FIG. 7 is a cross section taken along a line VII-VII in FIG. 6.

FIG. 8 is a perspective view of a part of a movable body.

FIG. 9(a) and 9(b) show one of cutting units viewed in a direction orthogonal to a liner axial direction.

FIG. 10 illustrates an initial state of the holding cutting mechanism.

FIG. 11(a) and 11(b) illustrate the movement of a second grip member and the cutting units.

FIG. 12 illustrates the rotation of the holding cutting mechanism.

FIG. 13(a) and 13(b) illustrate the movement of the second grip member and the cutting units.

FIG. 14(a) and 14(b) illustrate the movement of the cutting units.

FIG. 15 illustrates a condition where fiber bundles are cut.

### REFERENCE SIGNS LIST

1 FILAMENT WINDING APPARATUS
30 SUPPORTING UNIT
50 HELICAL WINDING UNIT
53 NOZZLE UNIT (FIBER BUNDLE GUIDE)
60 YARN END PROCESSOR
62 MOVEMENT DRIVE UNIT (FIRST DRIVE UNIT)
63 MOVING MOTOR (FIRST DRIVING SOURCE)
71 MAIN BODY
72 GRIPPING PORTION
73 CUTTING UNIT
73B BLADE PART
77 FIRST GRIP MEMBER
77B COMB TEETH PORTION (FIRST COMB TEETH PORTION)
78 SECOND GRIP MEMBER
78B COMB TEETH PORTION (SECOND COMB TEETH PORTION)
79 RECEIVING MEMBER (RECEIVER)
80 ROTATIONAL DRIVE UNIT (SECOND DRIVE UNIT)
81 ROTATING MOTOR (SECOND DRIVING SOURCE)
90 EXTENSION/CONTRACTION DRIVE UNIT (THIRD DRIVE UNIT)
91 EXTENSION/CONTRACTION MOTOR (THIRD DRIVING SOURCE)
96 FIRST MOVING CIRCULAR PLATE MEMBER (MOVING MEMBER)
F FIBER BUNDLE
L LINER

### DETAILED DESCRIPTION

### Filament Winding Apparatus

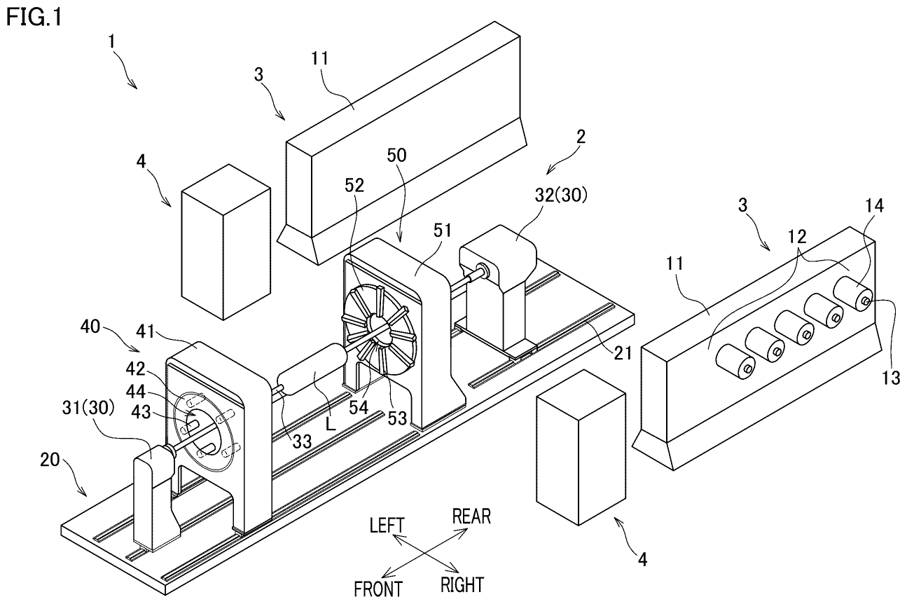

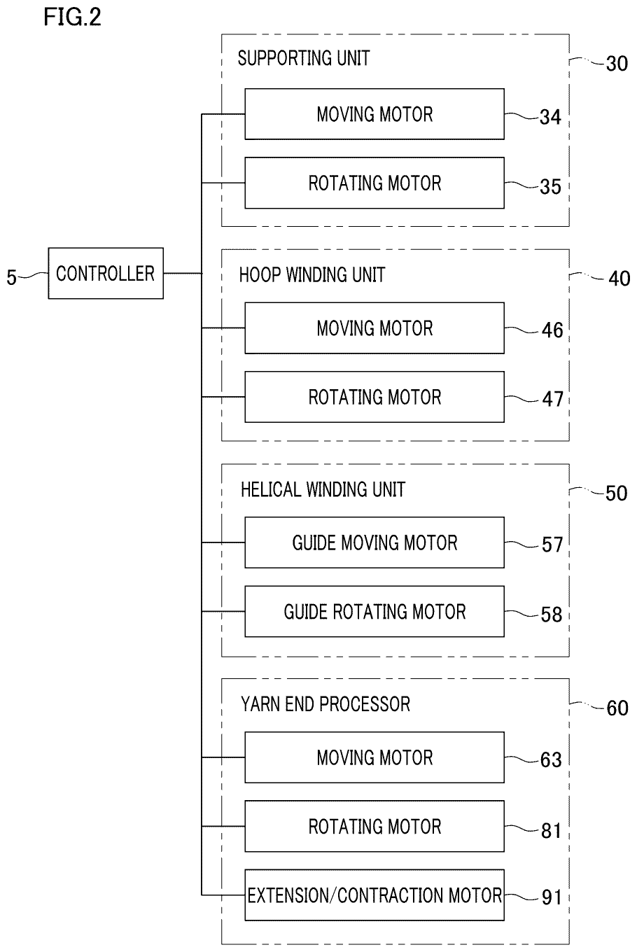

The following will describe a representative example of a filament winding apparatus. FIG. 1 is a perspective view of a filament winding apparatus 1. FIG. 2 is a block diagram of the electric configuration of the filament winding apparatus 1. For convenience of explanation, directions (a front-rear direction and a left-right direction) shown in FIG. 1 are defined below. The front-rear direction and the left-right direction are in parallel to a horizontal direction. The front-rear direction and the left-right direction are orthogonal to each other. Furthermore, a direction orthogonal to both the front-rear direction and the left-right direction is defined as an up-down direction. The up-down direction is a vertical direction in which the gravity acts.

The filament winding apparatus 1 is of a multiple-filaments feeding type, and configured to simultaneously wind fiber bundles (not illustrated in FIG. 1) onto a liner L. The filament winding apparatus 1 includes a winder 2, creel stands 3, and pretreatment units 4. On the whole, the filament winding apparatus 1 is substantially symmetrical in the left-right direction. The winder 2 is configured to wind the fiber bundles onto the cylindrical liner L. Each fiber bundle is obtained by, e.g., impregnating a thermosetting or thermoplastic synthetic-resin material into a fiber material such as a carbon fiber. The shape of the liner L may vary depending on the final product. For example, when the final product is a pressure tank, the liner L with dome portions at both ends of its cylindrical portion is used as shown in FIG. 1. The materials of the liner L include high-strength aluminum, metal, and resin. After the fiber bundles are wound onto the liner L, a thermosetting process such as baking or a cooling process is performed. As a result, the final product such as a high-strength pressure tank is produced.

For example, the creel stands 3 are provided on both sides of the winder 2 in the left-right direction. The creel stands 3 are provided, e.g., in the vicinity of a rear end portion of the winder 2 in the front-rear direction. Each creel stand 3 includes, e.g., a substantially rectangular-parallelepiped frame 11 extending in the front-rear direction. The frame 11 is provided with, e.g., one or more bobbin holder groups 12. For example, the bobbin holder groups 12 are provided to correspond to the respective nozzle units 53 of a helical winding unit 50 described later. Each bobbin holder group 12 includes plural (five in the present embodiment) bobbin holders 13 aligned in, e.g., the front-rear direction. Each bobbin holder 13 includes, e.g., an axis extending in the left-right direction. Each bobbin holder 13 rotatably supports a bobbin 14 on which a fiber bundle is wound. In the present embodiment, for example, nine bobbin holder groups 12 are provided, and five bobbins 14 are attached to each bobbin holder group 12. (Therefore, 45 bobbins 14 are provided in total.) Five fiber bundles are supplied together from the five bobbins 14 belonging to each bobbin holder group 12. The fiber bundles supplied from each creel stand 3 are wound onto the liner L by the helical winding unit 50. FIG. 1 illustrates two creel stands 3. However, the number of the creel stands 3 is not limited to this. To avoid complex figures, FIG. 1 illustrates only one of the bobbin holder groups 12.

The pretreatment units 4 are configured to perform a predetermined pretreatment (e.g., application of a tension) for the fiber bundles. Each pretreatment unit 4 is, e.g., provided between a corresponding creel stand 3 and the helical winding unit 50 (described later) in a running direction of the fiber bundles.

### Winder

The following will detail the winder 2. The winder 2 includes a base 20, supporting units 30 (a first supporting unit 31 and a second supporting unit 32), a hoop winding unit 40, and the helical winding unit 50.

The base 20 supports the supporting units 30, the hoop winding unit 40, and the helical winding unit 50. On an upper surface of the base 20, rails 21 are provided to extend in the front-rear direction. The supporting units 30 and the hoop winding unit 40 are movable in the front-rear direction along the rails 21. Meanwhile, for example, the position of the helical winding unit 50 is fixed with respect to the base 20. The first supporting unit 31, the hoop winding unit 40, the helical winding unit 50, and the second supporting unit 32 are provided in this order from the front side to the rear side.

The supporting units 30 include the first supporting unit 31 and the second supporting unit 32. The first supporting unit 31 is provided in front of the hoop winding unit 40. The second supporting unit 32 is provided behind the helical winding unit 50. Through a supporting shaft 33 extending in an axial direction of the liner L (i.e., in the front-rear direction), the supporting units 30 support the liner L to be rotatable about this shaft. The supporting units 30 include a moving motor 34 and a rotating motor 35 (see FIG. 2). The moving motor 34 is configured to move the supporting units 30 (the first supporting unit 31 and the second supporting unit 32) in the front-rear direction along the rails 21. The rotating motor 35 is configured to rotate the supporting shaft 33 so that the liner L is rotated about this shaft. The operations of the moving motor 34 and the rotating motor 35 are controlled by the controller 5.

The hoop winding unit 40 is configured to perform hoop-winding for a circumferential surface of the liner L. The hoop-winding is a way of winding the fiber bundles onto the liner L in a direction substantially orthogonal to the axial direction of the liner L. The hoop winding unit 40 includes, e.g., a main body portion 41, a rotation member 42, and plural (five in the present embodiment) bobbin holders 43. The main body portion 41 is movable in the front-rear direction along the rails 21. The rotation member 42 is an annular member with a passing hole 44 allowing the liner L to pass through. The rotation member 42 is supported by the main body portion 41 to be able to revolve around the shaft of the liner L. The bobbin holders 43 are attached to the rotation member 42 at regular intervals in the circumferential direction. Each bobbin holder 43 includes a rotational axis extending in the front-rear direction, and rotatably supports a bobbin (not illustrated) on which a fiber bundle is wound.

The hoop winding unit 40 includes a moving motor 46 and a rotating motor 47 (see FIG. 2). The moving motor 46 is configured to move the main body portion 41 in the front-rear direction along the rails 21. The rotating motor 47 is configured to cause the rotation member 42 to revolve around the shaft of the liner L. The operations of the moving motor 46 and the rotating motor 47 are controlled by the controller 5. When the hoop-winding is performed, the controller 5 rotates the rotation member 42 while causing the main body portion 41 to reciprocate along the rails 21. Because of this, fiber bundles are pulled out from the respective bobbins revolving around the liner L and are simultaneously hoop-wound onto the circumferential surface of the liner L.

The helical winding unit 50 is configured to perform helical-winding for the circumferential surface of the liner L. The helical winding is a way of winding the fiber bundles onto the liner L in a direction substantially parallel to the axial direction of the liner L. The helical winding unit 50 includes, e.g., a main body portion 51, a frame member 52, and plural (nine in the present embodiment) nozzle units 53. The main body portion 51 is fixed to, e.g., the base 20. The frame member 52 is an annular member with a passing hole 54 allowing the liner L to pass through. The frame member 52 is supported by the main body portion 51. The nozzle units 53 are radially arranged around the shaft of the liner L. Each nozzle unit 53 is attached to the frame member 52.

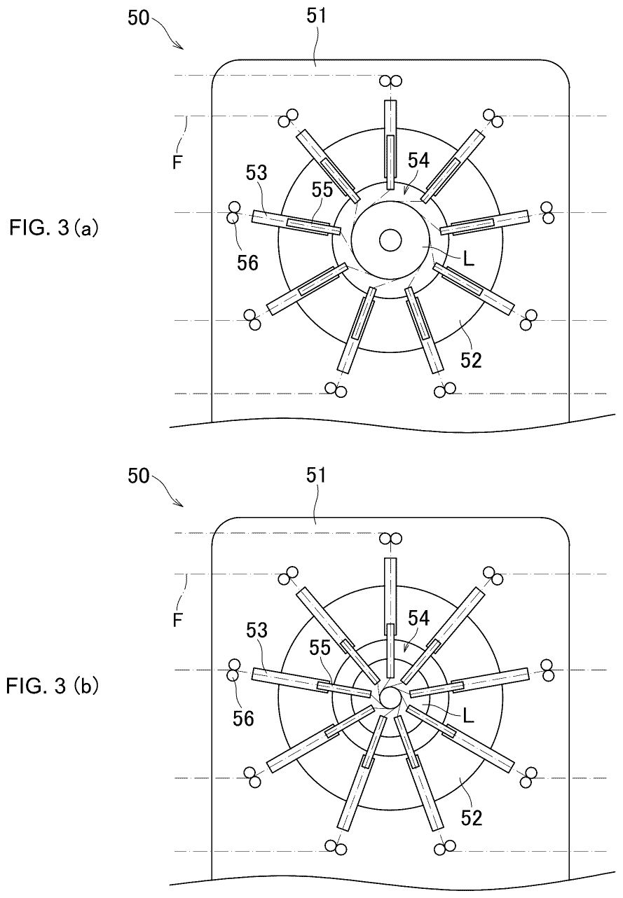

FIG. 3(a) and 3(b) are front views of the helical winding unit 50. To be more specific, FIG. 3(a) shows a situation when fiber bundles F are wound onto the cylindrical portion of the liner L. FIG. 3(b) shows a situation when the fiber bundles F are wound onto a dome portion of the liner L. Each nozzle unit 53 includes a guide member 55 configured to guide a fiber bundle F to the liner L. The guide member 55 extends in a radial direction of the liner L (hereinafter, this will be simply referred to as the radial direction), is movable in the radial direction, and is rotatable about a rotational axis extending in the radial direction. A guide roller 56 is provided radially outside each nozzle unit 53. Five fiber bundles F pulled out from each bobbin holder group 12 of each creel stand 3 are introduced into one guide member 55 via the guide roller 56, and then supplied to the liner L from a leading end of this guide member 55.

The helical winding unit 50 includes a guide moving motor 57 and a guide rotating motor 58 (see FIG. 2). The guide moving motor 57 is configured to move guide members 55 simultaneously in the radial directions. The guide rotating motor 58 is configured to rotate the guide members 55 simultaneously about those rotational axes. The operations of the guide moving motor 57 and the guide rotating motor 58 are controlled by the controller 5. When the helical-winding is performed, the controller 5 causes the liner L to pass through the passing hole 54 while slowly rotating the liner L about its shaft. At the same time, the controller 5 suitably causes the guide member 55 of each nozzle unit 53 about a corresponding rotational axis while suitably moving the guide member 55 of each nozzle unit 53 in the radial direction. As a result, the five fiber bundles F are properly pulled out from the leading end of the guide member 55 of each nozzle unit 53, and the 45 fiber bundles F in total are simultaneously helical-wound onto the circumferential surface of the liner L.

### Yarn End Processor

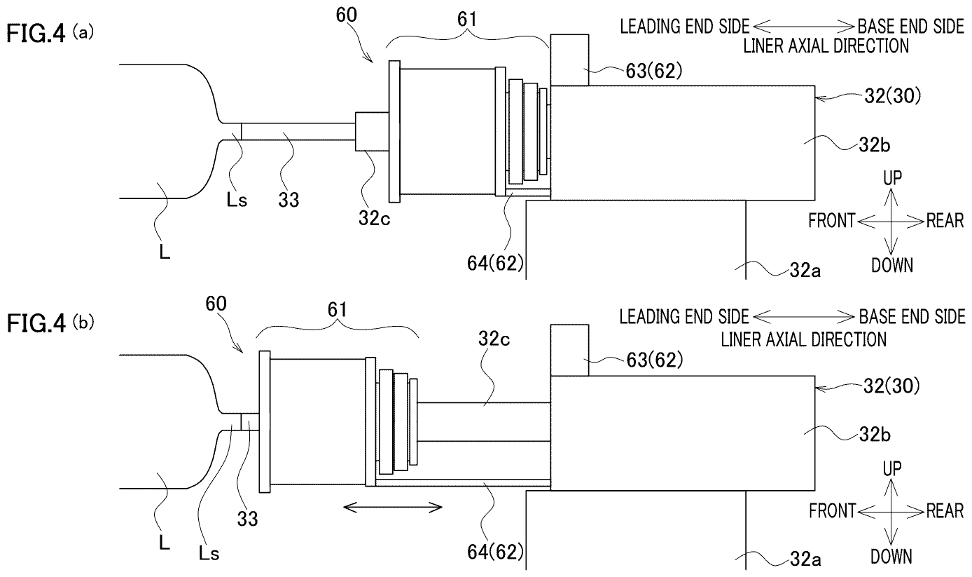

The following will further describe the filament winding apparatus 1. The filament winding apparatus 1 includes a yarn end processor 60 (see FIG. 4(a) and 4(b)). FIG. 4(a) and 4(b) are profiles of the yarn end processor 60 and its surroundings. Hereinafter, a direction in which the fiber bundles F run will be referred to as a fiber bundle running direction for convenience of explanation. Furthermore, the front-rear direction may be referred to as a liner axial direction (an axial direction of). The front side in the front-rear direction may be referred to as the leading end side in the liner axial direction. The rear side in the front-rear direction may be referred to as the base end side in the liner axial direction.

The yarn end processor 60 is provided for holding and cutting the fiber bundles F which are wound onto the liner by the helical winding unit 50. To be more specific, for example, the filament winding apparatus 1 is able to alternately perform the hoop-winding and the helical-winding plural times for a given liner L. For example, after predetermined helical-winding is completed, the yarn end processor 60 cuts parts which are of the respective fiber bundles F and which are positioned between the nozzle units 53 (fiber bundle guides) and the liner L in the fiber bundle running direction. The yarn end processor 60 also holds upstream parts which are of the cut fiber bundles F and which are positioned on the upstream side (the nozzle unit 53 side) in the fiber bundle running direction until yarn threading for the next helical-winding is performed.

As shown in FIG. 4(a) and 4(b), the yarn end processor 60 is attached to, e.g., the second supporting unit 32. The second supporting unit 32 includes, e.g., a foundation 32a, a head portion 32b, and a chucking portion 32c. The foundation 32a is movable in the front-rear direction along the rails 21 (see FIG. 1). The head portion 32b is fixed to an upper portion of the foundation 32a. The yarn end processor 60 is provided at, e.g., the head portion 32b. The chucking portion 32c is structured so that the supporting shaft 33 is attachable to the chucking portion 32c. The chucking portion 32c protrudes forward from, e.g., the head portion 32b.

As shown in FIG. 4(a) and 4(b), the yarn end processor 60 includes a holding cutting mechanism 61 and a movement drive unit 62 (first drive unit). The holding cutting mechanism 61 is able to hold and cut the fiber bundles F. On the whole, the holding cutting mechanism 61 is substantially cylindrical in shape. The holding cutting mechanism 61 is arranged to surround, e.g., the chucking portion 32c. The holding cutting mechanism 61 is movable relative to the head portion 32b in the liner axial direction. The movement drive unit 62 is able to move the holding cutting mechanism 61 in the liner axial direction. The movement drive unit 62 includes a moving motor 63 (first driving source) and a power transmission unit 64. The moving motor 63 is, e.g., a known stepping motor. The moving motor 63 is electrically connected to the controller 5 (see FIG. 2). The power transmission unit 64 is configured to transmit the power of the moving motor 63 to the holding cutting mechanism 61. The power transmission unit 64 includes, e.g., a known rack-and-pinion mechanism. With the above-described arrangements, the holding cutting mechanism 61 is movable between a retracting position (see FIG. 4(a)) which is separated from the liner L and a process position (see FIG. 4(b)) which is closer to the liner L than the retracting position in the liner axial direction.

### Details of Yarn End Processor

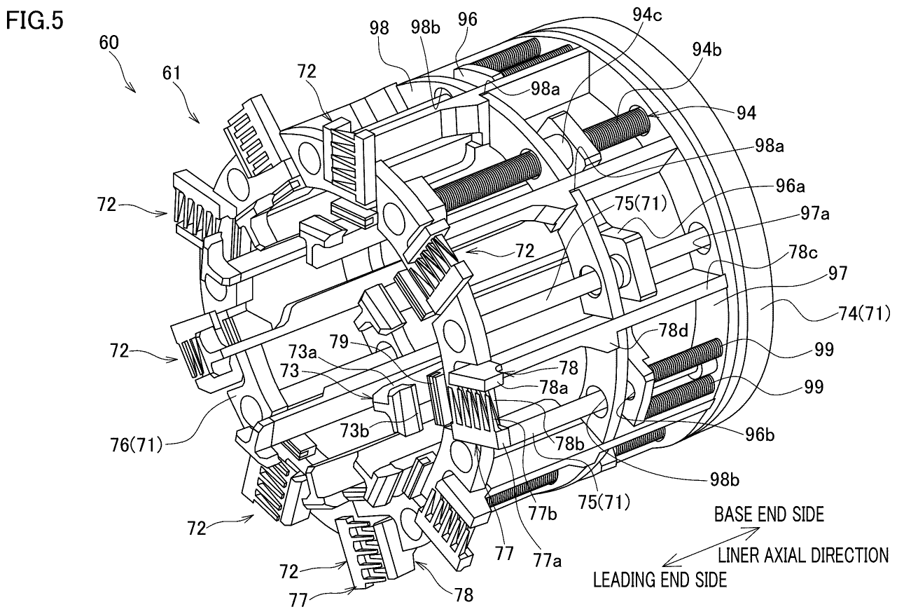

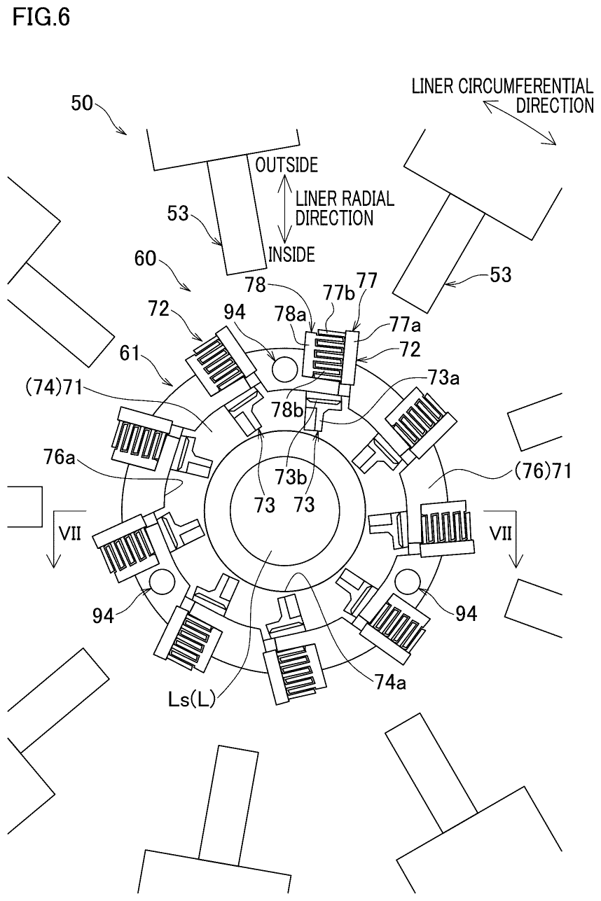

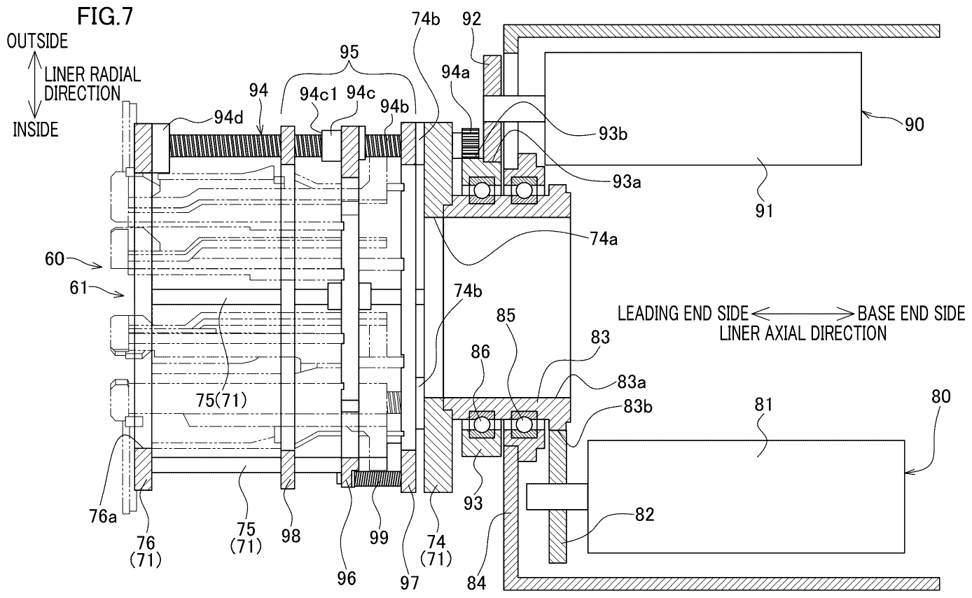

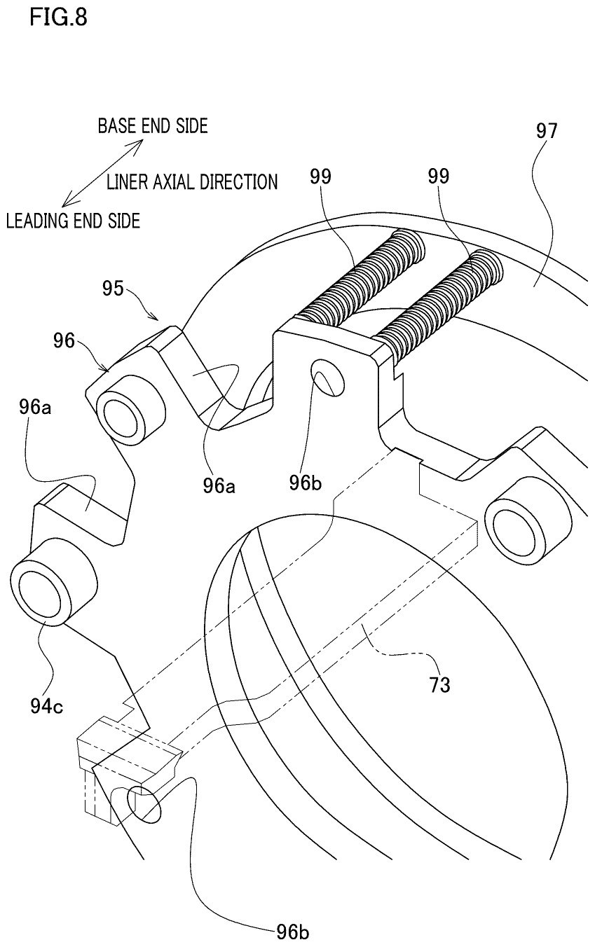

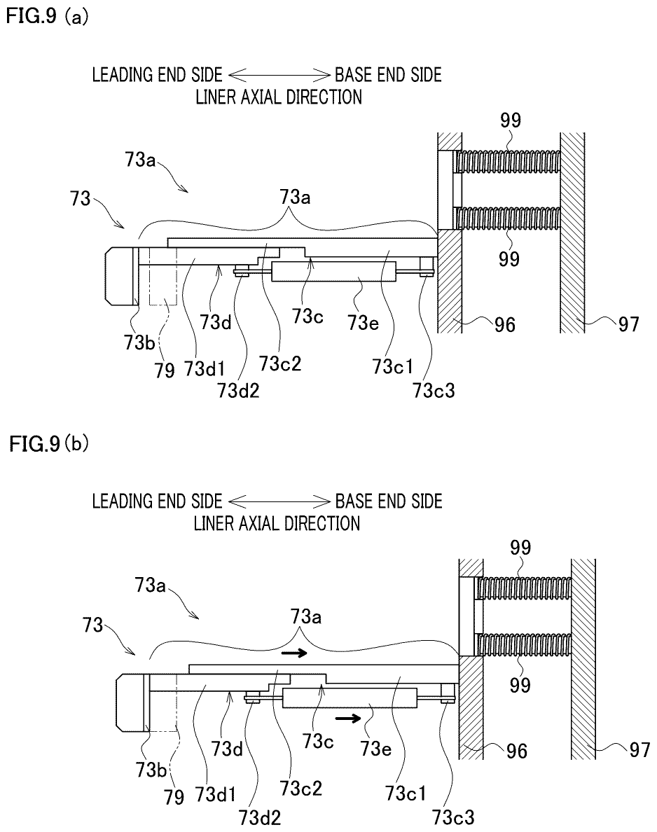

The yarn end processor 60 is structured as described below so that the yarn end processor 60 is driven by fewer driving sources than known driving sources. The following will detail the yarn end processor 60 with reference to FIGS. 5 to 9(b). FIG. 5 is a perspective view of the holding cutting mechanism 61. FIG. 6 is a front view of the holding cutting mechanism 61 and its surroundings. FIG. 7 is a cross section taken along a line VII-VII in FIG. 6. FIG. 8 is a perspective view of a part of a later-described movable body 95. FIG. 9(a) and 9(b) show one of later-described cutting units 73 viewed in a direction orthogonal to the liner axial direction. Hereinafter, a circumferential direction of the liner L will be referred to as a liner circumferential direction (circumferential direction). Furthermore, a radial direction of the liner L will be referred to as a liner radial direction. The liner radial direction is orthogonal to both the liner axial direction and the liner circumferential direction.

For easy explanation, to begin with, the following will describe members for holding the fiber bundles F and members for cutting the fiber bundles F in the holding cutting mechanism 61. After that, an arrangement for driving these members will be detailed.

As shown in FIGS. 5 and 6, the holding cutting mechanism 61 includes a main body 71, gripping portions 72, and cutting units 73. The main body 71 forms an outer frame of the holding cutting mechanism 61. The gripping portions 72 and the cutting units 73 are provided to correspond to the respective fiber bundles F. That is, in the present embodiment, the helical winding unit 50 is able to wind nine fiber bundles F simultaneously onto the liner L (see FIG. 3(a) and 3(b)). Accordingly, nine gripping portions 72 and nine cutting units 73 are provided. The gripping portions 72 and the cutting units 73 are provided at, e.g., a leading end portion of the holding cutting mechanism 61 on the leading end side in the liner axial direction. For example, the gripping portions 72 are aligned substantially at equal angular intervals in the liner circumferential direction. Similarly, the cutting units 73 are also aligned substantially at, e.g., equal angular intervals in the liner circumferential direction.

The main body 71 is configured to fix various members forming the holding cutting mechanism 61, or to movably support these members. On the whole, the main body 71 is, e.g., substantially cylindrical in shape. The main body 71 extends in the liner axial direction. For convenience of explanation, an end portion of the liner L in the liner axial direction will be referred to as a small diameter portion Ls (see FIG. 6). The main body 71 is structured so that the supporting shaft 33, the chucking portion 32c and the small diameter portion Ls (see FIG. 4; hereinafter, those will be referred to as the supporting shaft 33, etc.) are insertable into the main body 71. The main body 71 includes, e.g., a first fixing circular plate member 74, pillar portions 75, and a second fixing circular plate member 76 (see FIGS. 5 and 7, etc.).

The first fixing circular plate member 74 is substantially disc-shaped. The first fixing circular plate member 74 is provided in the vicinity of a base end portion of the holding cutting mechanism 61 on the base end side in the liner axial direction. A radially central portion of the first fixing circular plate member 74 is provided with an insertion hole 74a (see FIG. 7) allowing the supporting shaft 33, etc. to be inserted into in the liner axial direction. For example, stoppers 74b (see FIG. 7) are provided on a leading end face of the first fixing circular plate member 74 on the leading end side in the liner axial direction.

The pillar portions 75 are pillar-shaped members extending in the liner axial direction. Base end portions of the pillar portions 75 on the base end side in the liner axial direction are fixed to the first fixing circular plate member 74. The pillar portions 75 are aligned in, e.g., the liner circumferential direction. The second fixing circular plate member 76 is fixed to leading end portions of the pillar portions 75 on the leading end side in the liner axial direction.

The second fixing circular plate member 76 is substantially disc-shaped. The second fixing circular plate member 76 is provided in the vicinity of the leading end portion of the holding cutting mechanism 61 on the leading end side in the liner axial direction. The second fixing circular plate member 76 is fixed to the leading end portions of the pillar portions 75 on the leading end side in the liner axial direction. A radially central portion of the second fixing circular plate member 76 is provided with an insertion hole 76a (see FIG. 7) allowing the supporting shaft 33, etc. to be inserted into in the liner axial direction.

Each gripping portion 72 is able to sandwich and grip a corresponding fiber bundle F in the liner axial direction. Each gripping portion 72 is openable and closable in the liner axial direction. As shown in FIGS. 5 and 6, each of the gripping portions 72 includes a first grip member 77 and a second grip member 78. The following will describe one first grip member 77 and one second grip member 78. Other first grip members 77 and second grip members 78 are similarly structured.

For example, the first grip member 77 is fixed to the second fixing circular plate member 76 (i.e., the main body 71). As shown in FIGS. 5 and 6, the first grip member 77 includes a main body portion 77a and comb teeth portions 77b (first comb teeth portions). The main body portion 77a extends in, e.g., a predetermined direction (hereinafter, this will be referred to as an orthogonal direction for convenience of explanation; the orthogonal direction is not shown in the figures) orthogonal to both the liner axial direction and the liner circumferential direction. The comb teeth portions 77b protrude from the main body portion 77a substantially in the liner circumferential direction. The comb teeth portions 77b are aligned in the orthogonal direction.

The second grip member 78 is movable relative to the first grip member 77 in, e.g., the liner axial direction (as detailed later). As shown in FIGS. 5 and 6, the second grip member 78 includes a main body portion 78a, comb teeth portions 78b (second comb teeth portions) , and an extending portion 78c. The main body portion 78a extends in, e.g., the orthogonal direction. For example, the main body portion 78a opposes the main body portion 77a over the comb teeth portions 77b of the first grip member 77 in the liner circumferential direction. The comb teeth portions 78b protrude from the main body portion 78a toward the main body portion 77a substantially in the liner circumferential direction. The comb teeth portions 77b and the comb teeth portions 78b are alternated in the orthogonal direction. The extending portion 78c protrudes from the main body portion 78a toward the base end side in the liner axial direction. The extending portion 78c is movably supported by the later-described movable body 95. A protruding portion 78d (see FIG. 5) is formed at an intermediate part of the extending portion 78c in the liner axial direction. The protruding portion 78d protrudes in, e.g., the liner circumferential direction. The protruding portion 78d is provided for moving the second grip member 78 and a later-described third moving circular plate member 98 together in the liner axial direction.

The cutting units 73 are able to cut the respective fiber bundles F. As shown in FIGS. 5 and 6, each cutting unit 73 includes, e.g., an extending portion 73a and a blade part 73b. The extending portion 73a extends in the liner axial direction. The extending portion 73a is movably supported by the later-descried movable body 95 (as detailed later). The blade part 73b is provided at, e.g., a leading end portion of the extending portion 73a on the leading end side in the liner axial direction. The blade part 73b is provided outside the extending portion 73a in the liner radial direction. The blade part 73b protrudes toward, e.g., the base end side in the liner axial direction. The cutting units 73 are provided inside the gripping portions 72 in the liner radial direction (provided on the small diameter portion Ls side of the liner L). The cutting units 73 are, e.g., movable relative to the main body 71 in the liner axial direction (as detailed later).

In the liner axial direction, for example, receiving members 79 (receivers; see FIG. 5) are provided on the base end side of the cutting units 73. The receiving members 79 are provided to correspond to the respective cutting units 73. The receiving members 79 are fixed to, e.g., the second fixing circular plate member 76. Each receiving member 79 is provided on an extension line of a flight path of corresponding one of the cutting units 73 in the liner axial direction. That is, each receiving member 79 is aligned with a corresponding cutting unit 73 in the liner axial direction. The receiving members 79 are configured to make contact with the respective moving cutting units 73 (specifically, blade parts 73b) to sandwich the respective fiber bundles F with the cutting units 73.

The following will describe an arrangement for driving the main body 71, the gripping portions 72, and the cutting units 73. As described above, the holding cutting mechanism 61 is moved in the liner axial direction by the movement drive unit 62. Furthermore, as shown in FIG. 7, the yarn end processor 60 includes a rotational drive unit 80 (second drive unit) and an extension/contraction drive unit 90 (a third drive unit).

### Rotational Drive Unit

The rotational drive unit 80 is able to rotationally drive the entire holding cutting mechanism 61 including the main body 71 in the liner circumferential direction. As shown in FIG. 7, for example, the rotational drive unit 80 includes a rotating motor 81 (second driving source), a gear 82, and a ring gear 83. The power of the rotating motor 81 is transmitted to the first fixing circular plate member 74 via the gear 82 and the ring gear 83 (i.e., power transmission mechanism).

The rotating motor 81 is, e.g., a known stepping motor. The rotating motor 81 is independent from the moving motor 63. The rotating motor 81 is movable together with the holding cutting mechanism 61 in the liner axial direction. A housing of the rotating motor 81 is fixed to a base member 84 (see FIG. 7). The base member 84 is moved in the liner axial direction by the movement drive unit 62. The rotating motor 81 is electrically connected to the controller 5 (see FIG. 2).

The gear 82 is rotationally driven by the rotating motor 81. A rotational axis direction of the gear 82 is substantially in parallel to, e.g., the liner axial direction. The ring gear 83 is substantially cylindrical in shape. A rotational axis direction of the ring gear 83 is substantially in parallel to, e.g., the liner axial direction. The ring gear 83 is provided with an insertion hole 83a (see FIG. 7) into which the small diameter portion Ls, etc. is insertable in the liner axial direction. For example, a gear portion 83b meshed with the gear 82 is formed on an outer circumferential surface of a base end portion of the ring gear 83 on the base end side in the liner axial direction. For example, the ring gear 83 is rotatably supported by the base member 84 via a rolling bearing 85. The ring gear 83 is provided inside the base member 84 and the rolling bearing 85 in the liner radial direction. For example, the ring gear 83 rotatably supports a later-described ring gear 93 via a rolling bearing 86. The ring gear 83 is provided inside the rolling bearing 86 and a ring gear 93 in the liner radial direction. The first fixing circular plate member 74 is fixed to a leading end portion of the ring gear 83 on the leading end side in the liner axial direction. FIG. 7 shows the ring gear 83 as one member for easy understanding. However, the disclosure is not limited to this. The ring gear 83 may be formed by, e.g., connecting plural ring-shaped members which are separated in the liner axial direction to be rotatable together with each other.

### Extension/Contraction Drive Unit

The extension/contraction drive unit 90 is able to move (i.e., to extend and contract) the second grip members 78 and the cutting units 73 in the liner axial direction. As shown in FIG. 7, for example, the extension/contraction drive unit 90 includes an extension/contraction motor 91 (a third driving source), a gear 92, a ring gear 93, ball screw mechanisms 94, and the movable body 95. FIG. 7 shows only one of the ball screw mechanisms 94. The power of the extension/contraction motor 91 is transmitted to the ball screw mechanisms 94 via the gear 92 and the ring gear 93 (i.e., power transmission mechanism). As the movable body 95 moves in the liner axial direction in accordance with the movement of the ball screw mechanisms 94, the second grip members 78 and the cutting units 73 are moved in the liner axial direction.

The extension/contraction motor 91 is, e.g., a known stepping motor. The extension/contraction motor 91 is independent from the moving motor 63 and the rotating motor 81. A housing of the extension/contraction motor 91 is fixed to the above-described base member 84 (see FIG. 7). The extension/contraction motor 91 is electrically connected to the controller 5 (see FIG. 2). The gear 92 is rotationally driven by the extension/contraction motor 91. A rotational axis direction of the gear 92 is substantially in parallel to, e.g., the liner axial direction. For example, the ring gear 93 is provided radially outside the ring gear 83. A rotational axis direction of the ring gear 93 is substantially in parallel to, e.g., the liner axial direction. For example, the ring gear 93 is rotatably supported by the ring gear 83 via the rolling bearing 86. For example, a gear portion 93a meshed with the gear 92 is formed at a base end portion of an outer circumferential surface of the ring gear 93 on the base end side in the liner axial direction. A gear portion 93b meshed with a later-described gear 94a is formed at a leading end portion of the outer circumferential surface of the ring gear 93 on the leading end side in the liner axial direction.

The ball screw mechanisms 94 are provided for moving the movable body 95 in the liner axial direction. For example, three ball screw mechanisms 94 are provided substantially at equal angular intervals (see FIG. 6) in the liner circumferential direction. However, the number and angular intervals of the ball screw mechanisms 94 are not limited to those. As shown in FIGS. 5 and 7, each ball screw mechanism 94 includes the gear 94a, a screw shaft 94b, and a nut 94c. The gear 94a is arranged to be meshed with the gear portion 93b of the ring gear 93. The gear 94a is fixed to the screw shaft 94b. The screw shaft 94b extends from the gear 94a toward the leading end side in the liner axial direction. The nut 94c is screwed with the screw shaft 94b. The nut 94c is movable in the liner axial direction in accordance with the rotation of the screw shaft 94b. A first moving circular plate member 96 (described later) of the movable body 95 is fixed to the nut 94c. A pressing surface 94c1 which is able to press the third moving circular plate member 98 (described later) of the movable body 95 is formed at a leading end of the nut 94c in the liner axial direction. For example, a stopper 94d is provided in the vicinity of a leading end portion of the screw shaft 94b on the leading end side in the liner axial direction. The stopper 94d is provided on, e.g., a base end face of the second fixing circular plate member 76 on the base end side in the liner axial direction.

The movable body 95 movably supports the second grip members 78 and the cutting units 73. The movable body 95 is movable relative to the main body 71 in the liner axial direction. The movable body 95 is rotatable together with the main body 71 in the liner circumferential direction. As shown in FIGS. 5 and 7, for example, the movable body 95 includes the first moving circular plate member 96 (moving member), a second moving circular plate member 97, the third moving circular plate member 98, and coil springs 99.

The first moving circular plate member 96 is substantially disc-shaped. A thickness direction of the first moving circular plate member 96 is substantially in parallel to the liner axial direction. The first moving circular plate member 96 is fixed to each nut 94c, and movable together with the nut 94c in the liner axial direction. The first moving circular plate member 96 is provided with, e.g., cutouts 96a and through holes 96b (see FIGS. 5 and 8).

The cutouts 96a are provided for avoiding the interference of the first moving circular plate member 96 with extending portions 78c of the second grip members 78. For example, the cutouts 96a are provided at an outer portion of the first moving circular plate member 96 in the liner radial direction. The cutouts 96a are provided substantially at, e.g., equal angular intervals in the liner circumferential direction. The through holes 96b are provided for allowing the respective pillar portions 75 to insert into. For example, the through holes 96b are provided at the outer portion of the first moving circular plate member 96 in the liner radial direction (i.e., at a portion which is of the first moving circular plate member 96 and in which the cutouts 96a are not provided). Each through hole 96b penetrates the first moving circular plate member 96 in the liner axial direction. Base end portions of the cutting units 73 on the base end side in the liner axial direction are fixed to a leading end face of the first moving circular plate member 96 on the leading end side in the liner axial direction (see FIG. 8). Leading end portions of the coil springs 99 on the leading end side in the liner axial direction are fixed to a base end face of the first moving circular plate member 96 on the base end side in the liner axial direction.

The cutting units 73 are attached to the first moving circular plate member 96. The following will detail the cutting units 73. As shown in FIG. 9(a) and 9(b), the extending portion 73a of each cutting unit 73 includes a first extending member 73c, a second extending member 73d, and a coil spring 73e (an elastic portion).

The first extending member 73c extends in the liner axial direction. The first extending member 73c includes, e.g., a main body portion 73c1, a guide portion 73c2, and a spring attaching portion 73c3. The main body portion 73c1 is fixed to the first moving circular plate member 96. For example, a base end portion of the main body portion 73c1 on the base end side in the liner axial direction is fixed to the first moving circular plate member 96. The guide portion 73c2 is provided on the leading end side of the main body portion 73c1 in the liner axial direction. The guide portion 73c2 is able to guide the second extending member 73d in the liner axial direction. In a direction substantially orthogonal to the liner axial direction, the spring attaching portion 73c3 protrudes from, e.g., the base end portion of the main body portion 73c1 on the base end side in the liner axial direction. One end portion of the coil spring 73e is attached to the spring attaching portion 73c3.

The second extending member 73d extends in the liner axial direction. For example, the second extending member 73d is movable relative to the first extending member 73c (and the first moving circular plate member 96) in the liner axial direction via the coil spring 73e. To be more specific, the second extending member 73d includes, e.g., a main body portion 73d1 and a spring attaching portion 73d2. The main body portion 73d1 can be guided by, e.g., the guide portion 73c2 of the first extending member 73c in the liner axial direction. The blade part 73b is fixed to, e.g., a leading end of the main body portion 73d1 in the liner axial direction. In the same direction as the direction in which the spring attaching portion 73c3 of the first extending member 73c protrudes, the spring attaching portion 73d2 protrudes from, e.g., a base end portion of the second extending member 73d on the base end side in the liner axial direction. The other end portion of the coil spring 73e is attached to the second extending member 73d.

The coil spring 73e is, e.g., a known extension coil spring. The coil spring 73e extends along, e.g., the liner axial direction. The coil spring 73e is interposed between the first extending member 73c and the second extending member 73d. In other words, the coil spring 73e is interposed between the first moving circular plate member 96 and the second extending member 73d. The coil spring 73e connects the first extending member 73c to the second extending member 73d so that the first extending member 73c and the second extending member 73d are movable relative to each other in the liner axial direction. One end portion of the coil spring 73e (base end portion of the coil spring 73e on the base side in the liner axial direction) is attached to the spring attaching portion 73c3 of the first extending member 73c. The other end portion of the coil spring 73e (leading end portion of the coil spring 73e on the leading side in the liner axial direction) is attached to the spring attaching portion 73d2 of the second extending member 73d.

When the blade part 73b is separated from the receiving member 79 (see FIG. 9(a)), the first extending member 73c and the second extending member 73d are movable together in the liner axial direction. When the blade part 73b is provided at a position to sandwich a fiber bundle F with the receiving member 79 (see FIG. 9(b)), the receiving member 79 regulates the movement of the blade part 73b toward the base end side in the liner axial direction. Because of this, the first extending member 73c moves relative to the second extending member 73d toward the base end side in the liner axial direction. In this regard, the coil spring 73e elastically deforms (extends) in the liner axial direction. When the coil spring 73e elastically deforms in the liner axial direction, the coil spring 73e is able to bias the blade part 73b toward a corresponding receiving member 79 by means of an elastic restoring force.

The second moving circular plate member 97 is substantially disc-shaped. A thickness direction of the second moving circular plate member 97 is substantially in parallel to the liner axial direction. The second moving circular plate member 97 is provided on the base end side of the first moving circular plate member 96 in the liner axial direction. The second moving circular plate member 97 is provided on the leading end side of the first fixing circular plate member 74 in the liner axial direction. The movement of the second moving circular plate member 97 toward the base end side in the liner axial direction is regulated by, e.g., each stopper 74b (see FIG. 7). The second moving circular plate member 97 includes, e.g., through holes 97a (see FIG. 5). The through holes 97a are provided for allowing the respective pillar portions 75 to insert into (specifically, loosely fit into). Base end portions of the second grip members 78 on the base end side in the liner axial direction are fixed to the leading end face of the second moving circular plate member 97 on the leading end side in the liner axial direction (see FIG. 5). To this leading end face, base end portions of the coil springs 99 on the base end side in the liner axial direction are also fixed (see FIGS. 5 and 8). With these arrangements, the first moving circular plate member 96 and the second moving circular plate member 97 are connected via the coil springs 99 to be movable relative to each other in the liner axial direction. In other words, each cutting unit 73 fixed to the first moving circular plate member 96 and each second grip member 78 fixed to the second moving circular plate member 97 are movable relative to each other in the liner axial direction.

The third moving circular plate member 98 is substantially disc-shaped. A thickness direction of the third moving circular plate member 98 is substantially in parallel to the liner axial direction. As shown in FIGS. 5 and 7, the third moving circular plate member 98 is provided on the leading end side of the first moving circular plate member 96 in the liner axial direction. The third moving circular plate member 98 is provided on the base end side of the second fixing circular plate member 76 in the liner axial direction. For example, as being pressed by each nut 94c via each pressing surface 94c1, the third moving circular plate member 98 is movable toward the leading end side in the liner axial direction. The movement of the third moving circular plate member 98 toward the leading end side in the liner axial direction is regulated by, e.g., each stopper 94d. The third moving circular plate member 98 includes, e.g., cutouts 98a and through holes 98b (see FIG. 5). The cutouts 98a extend radially inward from an outer circumferential surface of the third moving circular plate member 98. The cutouts 98a are engaged with the extending portions 78c of the second grip members 78. The through holes 98b are provided for allowing the respective pillar portions 75 to insert into (specifically, loosely fit into). A leading end face of the third moving circular plate member 98 on the leading end side in the liner axial direction is in contact with the base end faces of the protruding portions 78d of the second grip members 78 on the base end side in the liner axial direction (see FIG. 5). With these arrangements, the third moving circular plate member 98 is able to press the second grip members 78 toward the leading end side in the liner axial direction. The third moving circular plate member 98 can be pressed by the second grip members 78 toward the base end side in the liner axial direction.

Each coil spring 99 is, e.g., a known compression coil spring. The coil springs 99 connect the first moving circular plate member 96 and the second moving circular plate member 97 to be movable relative to each other in the liner axial direction (see FIGS. 5 and 8). When the coil springs 99 are compressed, the coil springs 99 bias (i) the first moving circular plate member 96 toward the leading end side in the liner axial direction and (ii) the second moving circular plate member 97 toward the base end side in the liner axial direction.

### Operation of Yarn End Processor

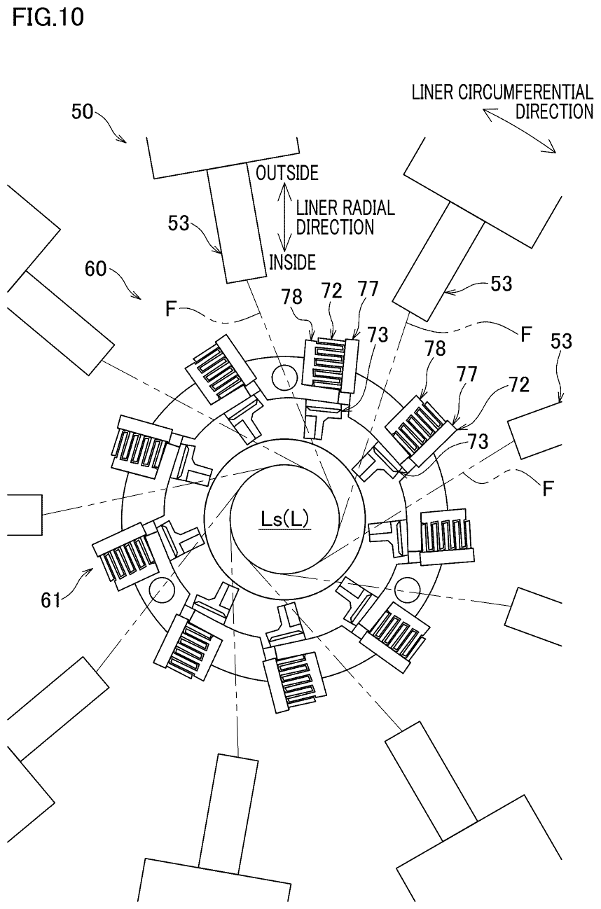

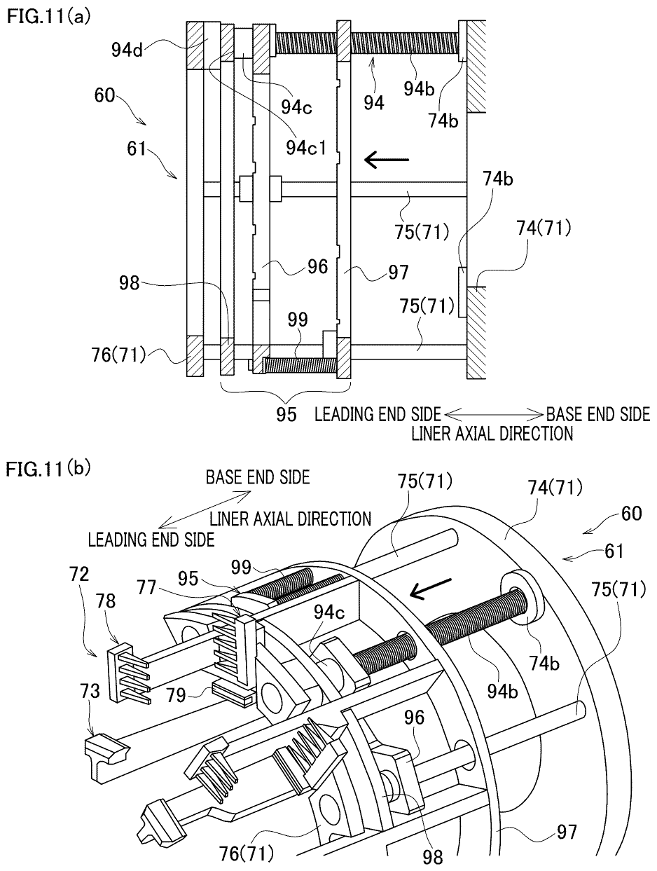

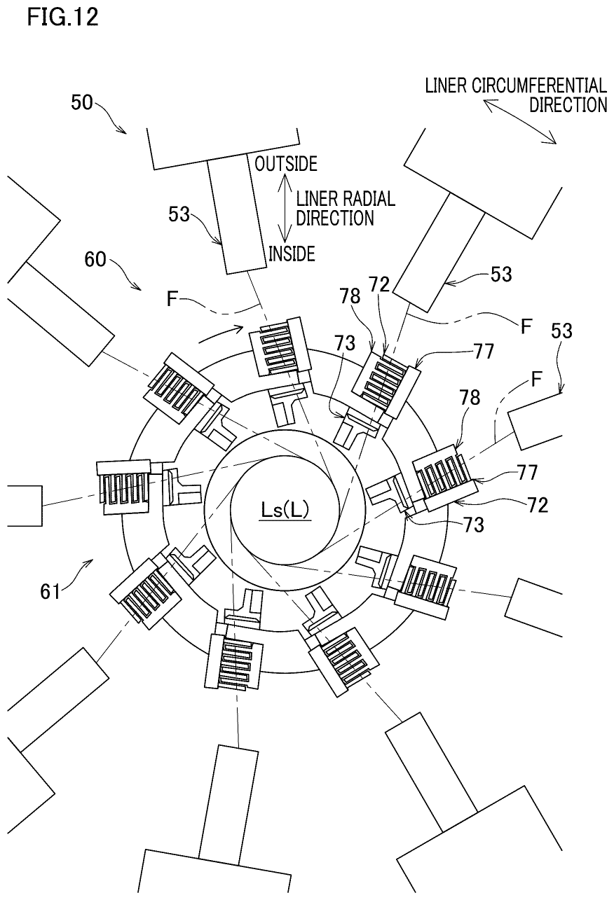

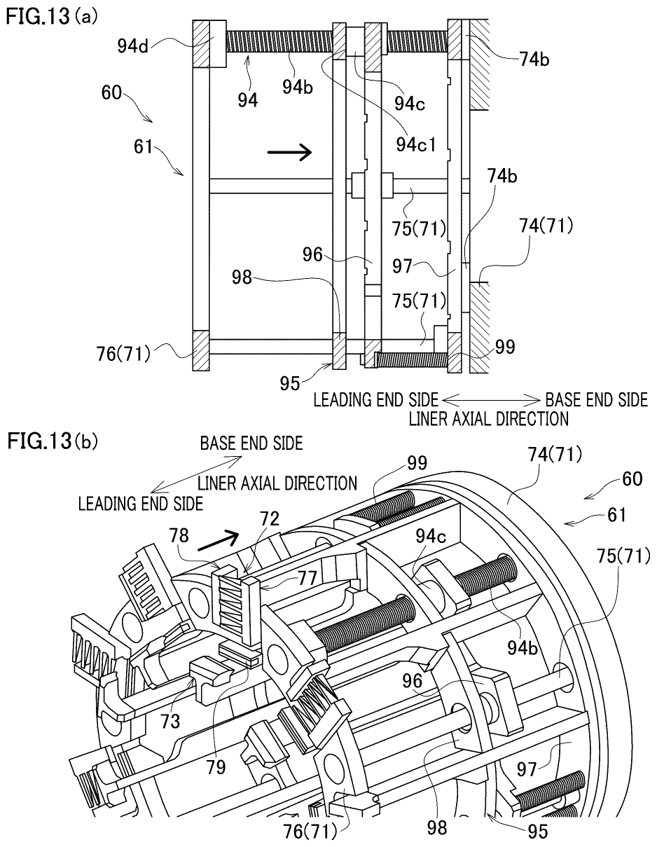

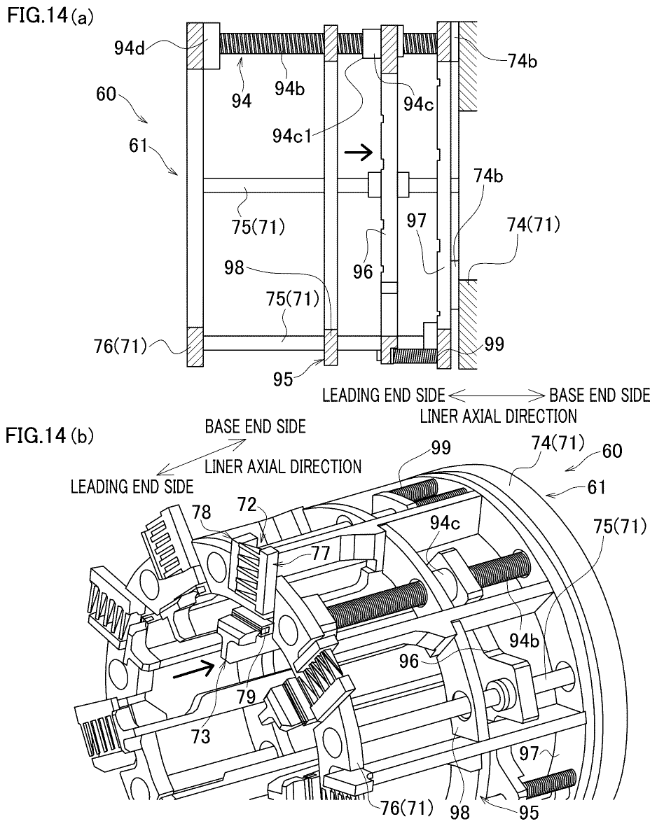

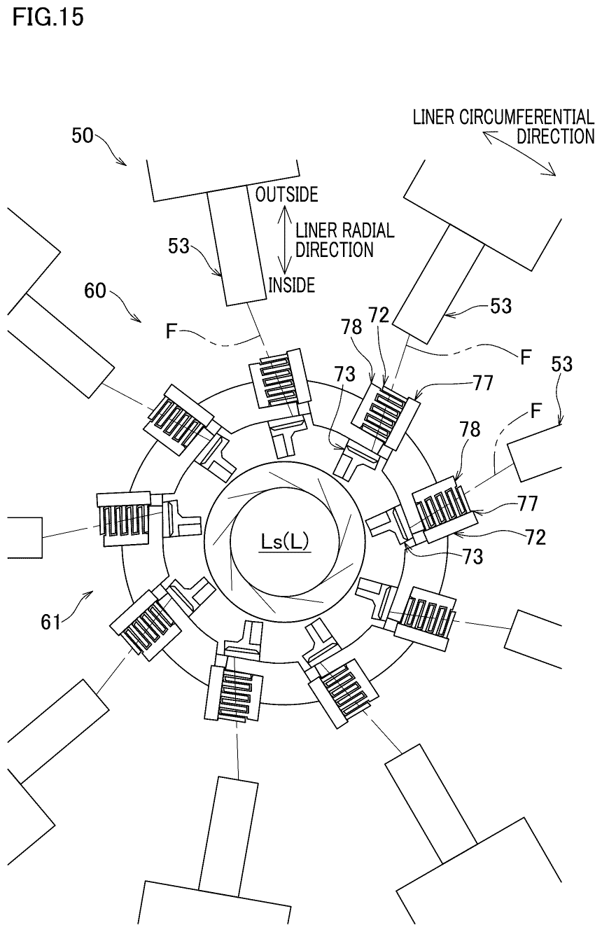

The following will describe the operation of the yarn end processor 60 arranged as described above, with reference to FIGS. 10 to 15. FIG. 10 illustrates an initial state of the holding cutting mechanism 61. FIG. 11(a) and 11(b) illustrate the movement of each second grip member 78 and each cutting unit 73. FIG. 12 illustrates the rotation of the holding cutting mechanism 61. FIG. 13(a) and 13(b) illustrate the movement of the second grip member 78 and the cutting unit 73. FIG. 14(a) and 14(b) illustrate the movement of the cutting unit 73. FIG. 15 illustrates a condition where the fiber bundles F are cut. FIGS. 10, 12, and 15 are front views similarly as FIG. 6. FIG. 11(a), 13(a), and 14(a) are cross sections similarly as FIG. 7. FIG. 11(a), 13(a), and 14(a) show only the main body 71 and the movable body 95 for easy understanding. FIG. 11(b), 13(b), and 14(b) are perspective views similarly as FIG. 5.

For example, the initial state of the yarn end processor 60 is as follows. The holding cutting mechanism 61 is provided at the retracting position (see FIG. 4(a)). As shown in FIG. 10, the fiber bundles F stop running while extending from the nozzle units 53 of the helical winding unit 50 to the small diameter portion Ls of the liner L. The gripping portions 72 and the cutting units 73 are positioned between the fiber bundles F in the liner circumferential direction.

To begin with, the controller 5 controls the moving motor 63 (see FIG. 2) to move the holding cutting mechanism 61 toward the leading end side in the liner axial direction. Because of this, the holding cutting mechanism 61 moves from the retracting position (see FIG. 4(a)) to the process position (see FIG. 4(b)).

Subsequently, the controller 5 controls the extension/contraction motor 91 (see FIG. 2) to drive the ball screw mechanisms 94 so that the movable body 95 moves toward the leading end side in the liner axial direction. Because of this, as shown in FIG. 11(a) and 11(b), the first moving circular plate member 96 moves together with the nut 94c of each ball screw mechanism 94 toward the leading end side in the liner axial direction. The second grip members 78 and the cutting units 73 are pressed by the first moving circular plate member 96 to move together with the first moving circular plate member 96 toward the leading end side in the liner axial direction. The second moving circular plate member 97 moves together with the coil springs 99 and the first moving circular plate member 96. The second moving circular plate member 97 moves together with the second grip members 78 toward the leading end side in the liner axial direction (see FIG. 11(b)). The third moving circular plate member 98 is pressed by, e.g., the nuts 94c to move together with the first moving circular plate member 96 toward the leading end side in the liner axial direction (see FIG. 11(b)).

As such, the movable body 95 moves together with the second grip members 78 and the cutting units 73 toward the leading end side in the liner axial direction. Because of this, while the first grip members 77 are positioned on the base end side of the fiber bundles F in the liner axial direction, the second grip members 78 are positioned on the leading end side of the fiber bundles F in the liner axial direction. In other words, the extension/contraction motor 91 is able to open and close the gripping portions 72 in the liner axial direction. Furthermore, the cutting units 73 are positioned on the leading end side of the fiber bundles F in the liner axial direction.

Subsequently, the controller 5 controls the rotating motor 81 (see FIG. 2) to rotate the holding cutting mechanism 61 in the liner circumferential direction (see FIG. 12). Because of this, the first grip members 77 and the second grip members 78 are provided so that the fiber bundles F are sandwiched between the first grip members 77 and the second grip members 78 in the liner axial direction. Furthermore, the cutting units 73 and the receiving members 79 are provided so that the fiber bundles F are sandwiched between the cutting units 73 and the receiving members 79 in the liner axial direction.

At this time, as only the rotation 81 is simply driven, the ball screw mechanisms 94 revolve in accordance with the rotation of the first fixing circular plate member 74 fixed to the ring gear 83 (see FIG. 7). Because of this, the gear 94a (see FIG. 7) may unintentionally rotate so that the ball screw mechanisms 94 are unintentionally driven. To avoid the rotation of the gear 94a at the time of rotation of the holding cutting mechanism 61, the controller 5 controls the extension/contraction motor 91 (see FIG. 2) according to need so that the ring gear 93 meshed with the gear 94a rotate. This prevents the unintentional rotation of the gear 94a.

Subsequently, the controller 5 controls the extension/contraction motor 91 (see FIG. 2) to drive the ball screw mechanisms 94 so that the movable body 95 moves toward the base end side in the liner axial direction. Because of this, as shown in FIG. 13(a) and 13(b), the first moving circular plate member 96 moves together with the nut 94c of each ball screw mechanism 94 toward the base end side in the liner axial direction. The cutting units 73 move together with the first moving circular plate member 96 toward the base end side in the liner axial direction. The second moving circular plate member 97 is pressed toward the base end side in the liner axial direction by the first moving circular plate member 96 via the coil springs 99. Because of this, the second moving circular plate member 97 moves substantially together with the first moving circular plate member 96 until the second moving circular plate member 97 makes contact with the stoppers 74b (see FIG. 13(a)). The second grip members 78 move together with the second moving circular plate member 97 toward the base end side in the liner axial direction. The third moving circular plate member 98 is pressed by the protruding portions 78d (see FIG. 5) of the second grip members 78 to move together with the second moving circular plate member 97 toward the base end side in the liner axial direction. As described above, the movable body 95 moves together with the second grip members 78 and the cutting units 73 toward the base end side in the liner axial direction until the second moving circular plate member 97 makes contact with the stoppers 74b. As a result, the gripping portions 72 are closed. That is, the fiber bundles F are gripped by the respective first grip members 77 and the respective second grip members 78.

Then, the controller 5 controls the extension/contraction motor 91 (see FIG. 2) to drive the ball screw mechanisms 94. As shown in FIG. 14(a), the movement of the second moving circular plate member 97 toward the base end side in the liner axial direction is regulated by the stoppers 74b. This also regulates the movement of the second grip members 78 and the third moving circular plate member 98 toward the base end side in the liner axial direction. Meanwhile, the first moving circular plate member 96 keeps moving toward the base end side in the liner axial direction while pressing the coil springs 99. The coil springs 99 are pressed and elastically deform (contract). Because of this, while the fiber bundles F are gripped by the respective gripping portions 72, the cutting units 73 move together with the first moving circular plate member 96 toward the base end side in the liner axial direction. The fiber bundles F are sandwiched between the blade parts 73b (see FIG. 9(b)) of the cutting units 73 and the receiving members 79 in the axial direction to be substantially simultaneously cut. To be more specific, after each blade part 73b makes contact with a corresponding receiving member 79 (see FIG. 9(b)), the controller 5 moves the first moving circular plate member 96 further toward the base end side in the liner axial direction. Because of this, the first extending member 73c moves relative to the second extending member 73d toward the base end side in the liner axial direction. As a result, the coil spring 73e elastically deforms in the liner axial direction as described above. The coil spring 73e having elastically deformed biases each blade part 73b toward a corresponding receiving member 79. As the blade parts 73b are biased as described above, downstream parts which are of the fiber bundles F and which are provided downstream of (i.e., the liner L side of) the gripping portions 72 in the fiber bundle running direction are cut. Because of this, while the gripping portions 72 are closed (i.e., the fiber bundles F are held), the liner L is separated from the helical winding unit 50 (see FIG. 15). With this operation, the cutting of the fiber bundles F is completed by the yarn end processor 60.

To describe the operation above more simply, when the second grip members 78 and the cutting units 73 move toward the leading end side in the liner axial direction (i.e., when the gripping portions 72 are opened), the second grip members 78 and the cutting units 73 move together with each other. When the second grip members 78 and the cutting units 73 move toward the base end side in the liner axial direction (i.e., the gripping portions 72 are closed), the second grip members 78 and the cutting units 73 move together with each other until the movement of the second moving circular plate member 97 is regulated by the stoppers 74b. After the movement of the second moving circular plate member 97 is regulated, only the cutting units 73 move toward the base end side in the liner axial direction. As such, the second grip members 78 operate differently from the cutting units 73 by using only the extension/contraction motor 91 as a driving source.

As described above, the yarn end processor 60 is driven by three drive units. With this arrangement, the number of driving sources is reduced to three. It is therefore possible to reduce the number of the driving sources necessary for the yarn end processor 60.

In each gripping portion 72, a fiber bundle is properly gripped by a teethed first grip member 77 and a teethed second grip member 78.

As the first moving circular plate member 96 is moved by the extension/contraction motor 91 in the liner axial direction, a fiber bundle F is sandwiched between the blade part 73b of each cutting unit 73 and each receiving member 79. Even when the first moving circular plate member 96 (and the first extending member 73c) is moved further in the liner axial direction, the coil spring 73e elastically deforms in the liner axial direction. This makes it possible to easily change the relative positions of the first moving circular plate member 96 (and the first extending member 73c) and the blade part 73b in the liner axial direction. It is therefore possible to prevent the damage of the yarn end processor 60 due to an excessive force applied to a position between the blade part 73b and the receiving member 79. The blade part 73b is biased toward the receiving member 79 by an elastic restoring force generated when the coil spring 73e elastically deforms. Because of this, the fiber bundle F sandwiched between the blade part 73b and the receiving member 79 is reliably cut by the blade part 73b.

The following will describe modifications of the above-described embodiment. The members identical with those in the embodiment above will be denoted by the same reference numerals and the explanations thereof are not repeated.
(1) In the embodiment above, the first grip members 77 and the second grip members 78 are teethed. However, the disclosure is not limited to this. Each gripping portion 72 may include a pair of opposing surfaces (not illustrated) opposing each other in the axial direction. A fiber bundle F may be sandwiched by such a pair of opposing surfaces. For example, at least one of these paired opposing surfaces may be roughened.
(2) In the embodiment above, each nut 94c is configured to press the third moving circular plate member 98 toward the leading end side in the liner axial direction via the pressing surface 94c1. However, the disclosure is not limited to this. Another member may be configured to press the third moving circular plate member 98 toward the leading end side in the liner axial direction.
(3) In the embodiment above, the movement of the first moving circular plate member 96 toward the base end side in the liner axial direction is regulated by each stopper 74b. However, the disclosure is not limited to this. This movement may be regulated by, e.g., the first fixing circular plate member 74.
(4) In the embodiment above, the movement of the third moving circular plate member 98 toward the leading end side in the liner axial direction is regulated by, e.g., each stopper 94d. However, the disclosure is not limited to this. This movement may be regulated by, e.g., the second fixing circular plate member 76.
(5) In the embodiment above, each first grip member 77 is fixed to the main body 71. However, the disclosure is not limited to this. For example, both the first grip member 77 and the second grip member 78 may be movable relative to the main body 71. To be more specific, for example, the principle of a rack-and-pinion mechanism may be applied. For example, a pair of racks (not illustrated) may be provided to be movable relative to the main body 71. For example, one of these paired racks may be provided at the first grip member 77 while the other of these paired racks is provided at the second grip member 78. The paired racks may extend in, e.g., the liner axial direction and oppose each other in a direction orthogonal to the liner axial direction. A pinion gear (not illustrated) supported by the main body 71 may be interposed between these paired racks. With this arrangement, as the second grip member 78 moves, the first grip member 77 may move in a direction opposite to the second grip member 78 in the liner axial direction. In this way, the first grip member 77 may be configured to move relative to the second grip member 78. That is, the gripping portions 72 may be opened or closed in this way.
(6) In the embodiment above, the coil springs 99 which are compression coil springs are provided between the first moving circular plate member 96 and the second moving circular plate member 97. However, the disclosure is not limited to this. For example, instead of the coil springs 99, one or more extension coil springs (not illustrated) may be interposed between the first moving circular plate member 96 and the third moving circular plate member 98.

In this instance, the protruding portion 78d of each second grip member 78 is preferably provided on the base end side of the third moving circular plate member 98 in the liner axial direction (not illustrated). With this arrangement, when the entire movable body 95 moves toward the base end side in the liner axial direction, each protruding portion 78d is pulled by the third moving circular plate member 98 toward the base end side in the liner axial direction. When only the first moving circular plate member 96 moves toward the base end side in the liner axial direction, each protruding portion 78d regulates the movement of the third moving circular plate member 98.
(7) In the embodiment above, the rotational drive unit 80 includes the ring gear 83. However, a transmission mechanism (rotation transmission mechanism) configured to transmit the power of the rotating motor 81 to the holding cutting mechanism 61 is not limited to this.
(8) In the embodiment above, the extension/contraction drive unit 90 includes the ring gear 93. However, a transmission mechanism (extension/contraction transmission mechanism) configured to transmit the power of the extension/contraction motor 91 to the holding cutting mechanism 61 is not limited to this.
(9) In the embodiment above, the coil spring 73e included in the extending portion 73a of each cutting unit 73 is an extension coil spring. However, the disclosure is not limited to this. For example, another type of a spring member may be provided instead of the coil spring 73e. Alternatively, an unillustrated rubber member which is able to elastically deform may be provided as the elastic portion.
(10) In the embodiment above, each cutting unit 73 includes the first extending member 73c and the second extending member 73d which are movable relative to each other. However, the disclosure is not limited to this. The entire cutting unit 73 may be fixed to the first moving circular plate member 96. In this instance, the extension/contraction drive unit 90 preferably includes, e.g., an unillustrated air cylinder (hydrostatic pressure cylinder) as the third driving source. This prevents an excessive force from being applied to a position between the blade part 73b and the receiving member 79.
(11) In the embodiment above, the yarn end processor 60 is attached to the second supporting unit 32. However, the disclosure is not limited to this. The yarn end processor 60 may be provided independently from, e.g., the second supporting unit 32.
(12) In the embodiment above, the front-rear direction is equivalent to the liner axial direction. However, the disclosure is not limited to this. The liner axial direction may be tilted relative to the front-rear direction, on condition that the liner axial direction has a horizontal component.

1. A filament winding apparatus configured to wind fiber bundles onto an outer circumferential surface of a liner, comprising:
a supporting unit which supports the liner;
a helical winding unit which includes fiber bundle guides and which is configured to helical-wind the fiber bundles onto the liner, the fiber bundle guides being aligned in a circumferential direction of the liner and configured to guide the respective fiber bundles to the liner; and
a yarn end processor which is able to grip and cut the fiber bundles, and
the yarn end processor including:
a main body which is movable relative to the supporting unit in an axial direction of the liner;
gripping portions which are provided at the main body, which are aligned in the circumferential direction, which are able to grip parts of the respective fiber bundles, and which are openable and closeable in the axial direction, the parts of the respective fiber bundles being positioned between the fiber bundle guides and the liner in a fiber bundle running direction;
cutting units which are provided at the main body to correspond to the respective gripping portions, which are able to cut parts of the fiber bundles gripped by the gripping portions, and which are movable in the axial direction, the parts of the fiber bundles gripped by the gripping portions being positioned between the gripping portions and the liner in the fiber bundle running direction;
a first drive unit which includes a first driving source and which is able to move the main body in the axial direction;
a second drive unit which includes a second driving source different from the first driving source and which is able to rotationally drive the main body in the circumferential direction; and
a third drive unit which includes a third driving source different from both the first driving source and the second driving source, which is able to open and close the gripping portions in the axial direction, and which is able to move the cutting units relative to the gripping portions in the axial direction while the gripping portions are closed.

2. The filament winding apparatus according to claim 1, wherein, each of the gripping portions includes:
a first grip member; and
a second grip member which is movable relative to the first grip member in the axial direction and which is able to grip corresponding one of the fiber bundles with the first grip member,
the first grip member includes first comb teeth portions which are aligned in an orthogonal direction orthogonal to the circumferential direction when viewed in the axial direction,
the second grip member includes second comb teeth portions which are aligned in the orthogonal direction, and
the first comb teeth portions and the second comb teeth portions are alternated in the orthogonal direction.

3. The filament winding apparatus according to claim 1, wherein, the yarn end processor includes
receivers which are provided to correspond to the cutting units and which are configured to sandwich the respective fiber bundles with the cutting units,
the third drive unit includes a moving member which is moved by the third driving source in the axial direction,
each of the cutting units includes:
a blade part which is aligned with corresponding one of the receivers in the axial direction, which is movable relative to the moving member in the axial direction, and which is able to sandwich one of the fiber bundles with the corresponding one of the receivers and to cut the one of the fiber bundles; and
an elastic portion which is interposed between the moving member and the blade part and which is able to elastically deform in the axial direction, and
when the blade part is provided at a position to sandwich the one of the fiber bundles with the corresponding one of the receivers, the elastic portion is able to elastically deform so as to bias the blade part toward the corresponding one of the receivers in the axial direction.
